(19) United States
(12) Patent Application Publication
(10) Pub. No.: US 2025/0154417 A1
(43) Pub. Date: May 15, 2025

(54) GASIFICATION UNIT, INTEGRATED GASIFICATION COMBINED CYCLE, AND OPERATING METHOD OF GASIFIER

(71) Applicant: MITSUBISHI HEAVY INDUSTRIES, LTD., Tokyo (JP)

(72) Inventors: Kazuhiro Domoto, Tokyo (JP); Eiki Tanaka, Tokyo (JP); Hiromi Ishii, Tokyo (JP); Shigetaka Takeda, Tokyo (JP); Kenichi Yamashita, Tokyo (JP); Ryusuke Fukushima, Tokyo (JP); Kohei Kawasaki, Tokyo (JP); Toru Katsuyama, Tokyo (JP); Masaya Iwasaki, Tokyo (JP)

(73) Assignee: MITSUBISHI HEAVY INDUSTRIES, LTD., Tokyo (JP)

(21) Appl. No.: 18/839,626

(22) PCT Filed: Feb. 10, 2023
(86) PCT No.: PCT/JP2023/004496

§ 371 Date: Aug. 19, 2024

(30) Foreign Application Priority Data
Feb. 25, 2022 (JP) 2022-028227

(51) Int. Cl. C10J 3/48

(52) U.S. Cl. CPC C10J 3/48; C10J 2200/09; C10J 2200/36; C10J 2300/0959

(57) ABSTRACT

The present invention includes: at least one feed hopper for retaining char separated from a generated gas that is generated in a gasifier; a char feed line for feeding char to the gasifier; a char flow rate adjustment device; a fuel feed line that feeds a carbon-containing solid fuel to the gasifier; a fuel flow rate adjustment device provided on the fuel feed line; an oxidant feed line for feeding an oxidant to the gasifier; an oxidant flow rate adjustment device provided on the oxidant feed line; and a control device. The control device is configured to control the char flow rate adjustment device so as to control the char flow rate depending on the load on a unit that uses a combustible gas, and to control at least one of the fuel flow rate adjustment device and the oxidant flow rate adjustment device depending on a total char level.

### TECHNICAL FIELD

The present disclosure relates to a gasification unit, an integrated gasification combined cycle, and an operating method of a gasifier.

The present application claims priority based on Japanese Patent Application No. 2022-028227 filed in Japan on Feb. 25, 2022, the contents of which are incorporated herein by reference.

### BACKGROUND ART

In the related art, a carbon-containing fuel gasification unit (coal gasification unit) that generates a combustible gas by supplying a carbonaceous feedstock such as coal into a gasifier and partially combusting and gasifying the carbonaceous feedstock is known as a gasifier.

PTL 1 discloses that, in the operation of a gasifier, the amount of char generated in the gasifier is estimated from the amount of pulverized coal and air supplied to the gasifier, and the estimated generated char amount is used as a target value to supply the char from a char supply unit.

### CITATION LIST

### Patent Literature

[PTL 1] Japanese Examined Patent Application Publication No. 6-78540

### SUMMARY OF INVENTION

### Technical Problem

In a case where a carbonaceous feedstock such as coal is supplied to a gasifier, there is a possibility that the amount of char generated in the gasifier may fluctuate due to variations in the properties of the carbonaceous feedstock or the like. In this regard, in the method described in PTL 1, when a difference occurs between the estimated value of the generated char amount and the actual generated char amount due to variations in the properties of coal or the like, an appropriate amount of char cannot be supplied to the gasifier, and the calorific value of the gas extracted in the gasifier is not stabilized, and thus the operation of the gasifier becomes unstable.

In view of the above circumstances, an object of at least one embodiment of the present disclosure is to provide a gasification unit, an integrated gasification combined cycle, and an operating method of a gasifier, in which it is possible to extract a gas having a small variation in calorific value of a generated gas and to realize a stable operation of a gasifier.

### Solution to Problem

In order to achieve the above object, a gasification unit according to at least one embodiment of the present disclosure includes: a gasifier for generating a combustible gas by using a carbonaceous feedstock and an oxygen containing gas; a char storage portion for storing char separated from the combustible gas generated in the gasifier; a char supply line for supplying the char from the char storage portion to the gasifier; a char flow rate adjusting device provided in the char supply line for adjusting a char flow rate, which is a flow rate of the char supplied to the gasifier; a fuel supply line for supplying the carbonaceous feedstock to the gasifier; a fuel flow rate adjusting device provided in the fuel supply line for adjusting a fuel flow rate, which is a flow rate of the carbonaceous feedstock supplied to the gasifier; an oxygen containing gas supply line for supplying the oxygen containing gas to the gasifier; an oxygen containing gas flow rate adjusting device provided in the oxygen containing gas supply line for adjusting an oxygen containing gas flow rate, which is a flow rate of the oxygen containing gas supplied to the gasifier; and a control device, and the control device is configured to control the char flow rate adjusting device to control the char flow rate to a flow rate determined according to a load index indicating a load of a unit using the combustible gas, and control at least one of the fuel flow rate adjusting device and the oxygen containing gas flow rate adjusting device to adjust at least one of the fuel flow rate and the oxygen containing gas flow rate based on a total char level indicating a storage amount of char in the char storage portion.

In order to achieve the above object, an integrated gasification combined cycle according to at least one embodiment of the present disclosure includes: the gasification unit; a gas turbine that is rotationally driven by combusting at least a part of a raw syngas generated in the gasifier; a steam turbine that is rotationally driven by steam generated in a heat recovery steam generator that introduces a turbine exhaust gas discharged from the gas turbine; and a generator that is connected to the gas turbine and/or the steam turbine for rotational driving.

In order to achieve the above object, an operating method of a gasifier according to at least one embodiment of the present disclosure includes: a step of controlling a flow rate of char supplied to the gasifier to a flow rate determined according to a load of a unit that uses a combustible gas generated in the gasifier; and a step of adjusting at least one of a flow rate of a carbonaceous feedstock to be supplied to the gasifier and a flow rate of an oxygen containing gas to be supplied to the gasifier according to a total char level indicating a storage amount of char in a char storage portion.

### Advantageous Effects of Invention

According to at least one embodiment of the present disclosure, there are provided a gasification unit, an integrated gasification combined cycle, and an operating method of a gasifier in which it is possible to extract a gas having a small variation in calorific value of the generated gas and to realize a stable operation of the gasifier.

### BRIEF DESCRIPTION OF DRAWINGS

FIG. 1 is a schematic configuration diagram of an integrated coal gasification combined cycle 10 to which a gasifier 101 according to an embodiment of the present disclosure is applied.

FIG. 2 is a diagram showing an example of the configuration of the gasifier 101 and the surroundings thereof in the integrated coal gasification combined cycle 10 shown in FIG. 1, and shows a gasification unit 40 according to the embodiment.

FIG. 3 is a diagram showing an example of a hardware configuration of a control device 38 shown in FIG. 2.

FIG. 4 is a diagram showing an example of a control circuit in the control device 38 shown in FIG. 2.

FIG. 5 is a diagram showing an example of a control circuit according to a comparative embodiment.

FIG. 6 is a diagram showing a time change in each of a char flow rate, a fuel flow rate, an air flow rate, and an air ratio in a case where the amount of char generated in the gasifier 101 increases with the passage of time due to a change in the properties of the pulverized coal or the like when the control shown in FIG. 5 is performed under a condition where a load index L is constant.

FIG. 7 is a diagram showing a time change in each of the char flow rate, the fuel flow rate, the air flow rate, and the air ratio in a case where the amount of char generated in the gasifier 101 increases with the passage of time due to a change in the properties of the pulverized coal or the like when the control shown in FIG. 4 is performed under a condition where the load index L is constant.

FIG. 8 is a diagram showing another example of the control circuit in the control device 38 shown in FIG. 2.

FIG. 9 is a diagram showing a time change in each of the char flow rate, the fuel flow rate, the air flow rate, and the air ratio in a case where the amount of char generated in the gasifier 101 increases with the passage of time due to a change in the properties of the pulverized coal or the like when the control shown in FIG. 8 is performed under a condition where the load index L is constant.

FIG. 10 is a diagram showing an example of a method for calculating a command value of a valve opening degree of a char flow regulation valve.

FIG. 11 is a diagram showing an example of the control shown in FIG. 10, and shows a relationship between time and an opening degree of the char flow regulation valve.

### DESCRIPTION OF EMBODIMENTS

Hereinafter, some embodiments of the present disclosure will be described with reference to the accompanying drawings. Dimensions, materials, shapes, relative arrangements, and the like of components described as embodiments or shown in the drawings are not intended to limit the scope of the invention, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, an expression such as “identical”, “equal”, or “homogeneous” representing a state where things are equal to each other does not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, the expressions “being provided with”, “comprising”, “including”, or “having” one component are not exclusive expressions excluding the presence of other components.

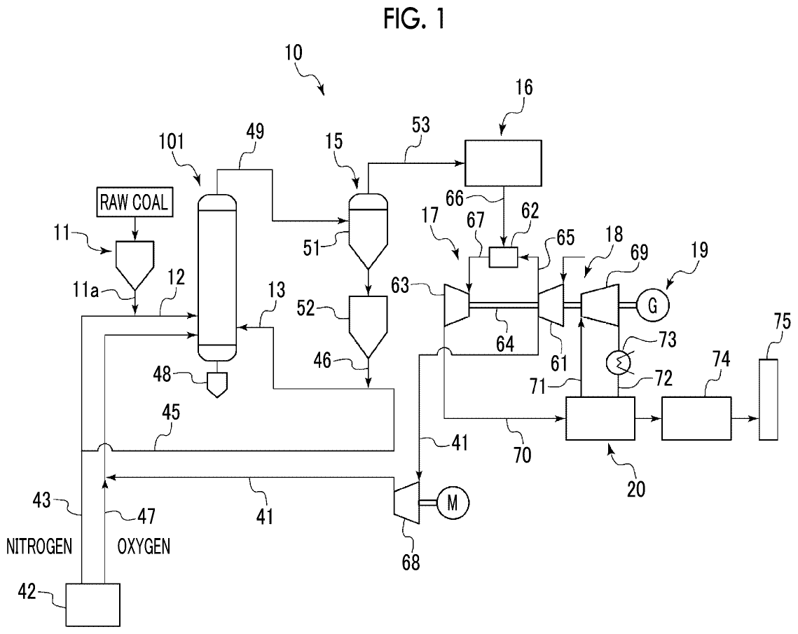

Hereinafter, an embodiment of the present disclosure will be described with reference to the drawings. FIG. 1 is a schematic configuration diagram of an integrated coal gasification combined cycle 10 to which a gasifier 101 according to an embodiment of the present disclosure is applied.

In the following description, the word “upper” indicates a vertically upper side, and “upper” in an upper portion, an upper surface, or the like indicates a part on the vertically upper side. Further, similarly, “lower” indicates a part on the vertically lower side, and a vertical direction is not exact and includes an error.

(Outline Configuration of Integrated coal Gasification Combined Cycle)

In the integrated coal gasification combined cycle (IGCC) 10 to which the gasifier 101 according to the present embodiment is applied, air is used as a main oxygen containing gas, and an air combustion type for generating a combustible gas (raw syngas) from fuel is adopted in the gasifier 101. Then, the integrated coal gasification combined cycle 10 cleans up the raw syngas generated in the gasifier 101 with the gas clean-up unit 16 and makes the raw syngas as a fuel gas, which is then supplied to a gas turbine 17 to generate power. That is, the integrated gasification combined cycle 10 according to the present embodiment is an air combustion type (air blowing) power generation unit. In the present embodiment, the air combustion type is described, but an oxygen combustion type (oxygen blowing) may be used. For example, carbonaceous feedstock, such as coal, is used as the fuel supplied to the gasifier 101.

As shown in FIG. 1, a integrated coal gasification combined cycle (integrated gasification combined cycle) 10 includes a coal feeding unit 11, the gasifier 101, a char recovery unit 15, the gas clean-up unit 16, the gas turbine 17, a steam turbine 18, a generator 19, and a heat recovery steam generator (HRSG) 20.

The coal feeding unit 11 is supplied with coal, which is a carbonaceous feedstock, as raw coal, and pulverizes the coal in a coal mill (not shown) to produce pulverized coal, which is pulverized into fine particles. The pulverized coal produced in the coal feeding unit 11 is pressurized by a nitrogen gas which is a transporting inert gas supplied from an air separation unit 42 to be described later at an outlet of a coal feed line 11a, and is supplied toward the gasifier 101. The inert gas is an inert gas having an oxygen content of approximately 5% by volume or less, and a nitrogen gas, a carbon dioxide gas, an argon gas and the like are typical examples. However, the inert gas is not necessarily limited to approximately 5% by volume or less.

Pulverized coal produced by the coal feeding unit 11 is supplied to the gasifier 101, and char (unreacted part and ash content of coal) recovered by the char recovery unit 15 is supplied to the gasifier 101 for the purpose of reusing energy.

In addition, a compressed air supply line 41 from the gas turbine 17 (compressor 61) is connected to the gasifier 101. A pressure of some of the compressed air, which is compressed by the gas turbine 17, is boosted by a booster 68 to a predetermined pressure to be suppliable to the gasifier 101. The air separation unit 42 separates nitrogen and oxygen from the air in the atmosphere, and is connected to the gasifier 101 as the fuel supply line 12 after the air separation unit 42 and the coal feed line 11a from the coal feeding unit 11 are connected to each other by a first nitrogen supply line 43. In addition, a second nitrogen supply line 45 branching off from the first nitrogen supply line 43 is also connected to a char return line 46 from the char recovery unit 15 and then connected to the gasifier 101 as the char supply line 13. Furthermore, the air separation unit 42 is connected to the compressed air supply line 41 by an oxygen supply line 47. Then, the nitrogen separated by the air separation unit 42 is circulated through the first nitrogen supply line 43 and the second nitrogen supply line 45 and is used as a carrier gas for coal or char. In addition, the oxygen separated by the air separation unit 42 is circulated through the oxygen supply line 47 and the compressed air supply line 41, and is used as the oxygen containing gas (air, oxygen) in the gasifier 101.

The gasifier 101 is configured in, for example, a two-stage jetting bed type, and partially combusts coal (pulverized coal) and char, which are supplied therein, with an oxygen containing gas (air, oxygen) to gasify and make a raw syngas. The gasifier 101 is provided with a foreign matter capture system 48 that discharges coal, ash content (coal ash), or the like to the outside. Then, a first raw syngas line 49 that supplies the raw syngas to the char recovery unit 15 is connected to the gasifier 101 such that the raw syngas containing the char can be discharged. In this case, the syngas cooler (gas cooler) (not shown) may be provided in the first raw syngas line 49 to cool the raw syngas to a predetermined temperature, and then the raw syngas may be supplied to the char recovery unit 15.

The char recovery unit 15 includes a collecting device 51 and a char supply hopper 52. In this case, the collecting device 51 is configured with one or a plurality of cyclones or porous filters, and can separate the char contained in the raw syngas generated in the gasifier 101. Then, the raw syngas from which the char is separated is sent to the gas clean-up unit 16 through the second raw syngas line 53. The char supply hopper 52 stores the char separated from the raw syngas by the collecting device 51. A bin may be disposed between the collecting device 51 and the char supply hopper 52, and a plurality of char supply hoppers 52 may be connected to the bin. Then, the char return line 46 from the char supply hopper 52 is connected to the second nitrogen supply line 45.

The gas clean-up unit 16 removes impurities, such as sulfur compounds and nitrogen compounds, from the raw syngas, from which the char has been separated by the char recovery unit 15, to clean up the gas. Then, the gas clean-up unit 16 cleans up the raw syngas to produce a fuel gas and supplies the fuel gas to the gas turbine 17. In addition, since the raw syngas from which the char is separated contains a sulfur compound (H₂S or the like), the gas clean-up unit 16 removes and recovers the sulfur compound by using an amine absorbing liquid or the like, and effectively uses the sulfur compound as gypsum or the like.

The gas turbine 17 includes the compressor 61, a combustor 62, and a turbine 63. The compressor 61 and the turbine 63 are connected to each other by a rotary shaft 64. The combustor 62 is connected to a compressed air supply line 65 from the compressor 61, is connected to a fuel gas supply line 66 from the gas clean-up unit 16, and is connected to a combustion gas supply line 67 extending toward the turbine 63. In addition, the gas turbine 17 is provided with the compressed air supply line 41 extending from the compressor 61 to the gasifier 101, and is provided with the booster 68 midway. Therefore, in the combustor 62, some of compressed air supplied from the compressor 61 and at least some of a fuel gas supplied from the gas clean-up unit 16 are mixed and combusted to generate a combustion gas, and the generated combustion gas is supplied toward the turbine 63. Then, the turbine 63 rotates the rotary shaft 64 with the supplied combustion gas to rotationally drive the generator 19.

The steam turbine 18 includes a turbine 69 that is connected to the rotary shaft 64 of the gas turbine 17, and the generator 19 is connected to a base end portion of the rotary shaft 64. In addition, the steam turbine 18 and the gas turbine 17 do not have to be on the same shaft to rotationally drive one generator 19, but may be on different shafts to rotationally drive a plurality of generators. The heat recovery steam generator 20 is connected to an exhaust gas line 70 from the gas turbine 17 (turbine 63), and generates steam by exchanging heat between the water supplied to the heat recovery steam generator 20 and the exhaust gas from the turbine 63.

A steam supply line 71 is provided between the heat recovery steam generator 20 and the turbine 69 of the steam turbine 18, a supply water line 72 is also provided, and a condenser 73 is provided on the supply water line 72. Further, the steam generated by the heat recovery steam generator 20 may include steam generated by heat exchange with the raw syngas in the syngas cooler (not shown) of the gasifier 101. Therefore, the turbine 69 of the steam turbine 18 is rotationally driven by the steam supplied from the heat recovery steam generator 20, and the rotary shaft 64 is rotated to rotationally drive the generator 19. An exhaust gas purification unit 74 is provided between the outlet of the heat recovery steam generator 20 and a stack 75.

Here, the operation of the integrated coal gasification combined cycle 10 of the present embodiment will be described.

In the integrated coal gasification combined cycle 10 according to the present embodiment, when raw coal (coal) is supplied to the coal feeding unit 11, the coal is pulverized into fine particles in the coal feeding unit 11 to become pulverized coal. The pulverized coal produced by the coal feeding unit 11 flows through the first nitrogen supply line 43 from the air separation unit 42 and is supplied to the gasifier 101 through the fuel supply line 12 by the nitrogen supplied thereto.

In addition, the char recovered by the char recovery unit 15 to be described later flows from the air separation unit 42 through the second nitrogen supply line 45 and is supplied to the gasifier 101 through the char supply line 13 by the nitrogen supplied thereto. Further, after the pressure of the compressed air bled from the gas turbine 17 to be described later is boosted by the booster 68, the compressed air is supplied to the gasifier 101 through the compressed air supply line 41 together with oxygen supplied from the air separation unit 42.

In the gasifier 101, supplied pulverized coal and char are combusted by compressed air (oxygen) and pulverized coal, and the char are gasified to generate a raw syngas. Then, the raw syngas is discharged from the gasifier 101 through the first raw syngas line 49 and is sent to the char recovery unit 15.

In the char recovery unit 15, first, the raw syngas is supplied to the collecting device 51 and the fine-grained char contained in the raw syngas is separated. Then, the raw syngas from which the char is separated is sent to the gas clean-up unit 16 through the second raw syngas line 53. In contrast, the fine-grained char separated from the raw syngas is accumulated in the char supply hopper 52, is returned to the gasifier 101 through the char return line 46, and is recycled.

A raw syngas from which char is separated by the char recovery unit 15 is subjected to gas clean-up in the gas clean-up unit 16 as impurities such as sulfur compounds and nitrogen compounds are removed, and thereby a fuel gas is produced. The compressor 61 generates compressed air and supplies the compressed air to the combustor 62. The combustor 62 generates a combustion gas by combusting the compressed air supplied from the compressor 61 and the fuel gas supplied from the gas clean-up unit 16. The turbine 63 is rotationally driven by the combustion gas to rotationally drive the compressor 61 and the generator 19 through the rotary shaft 64. In this manner, the gas turbine 17 can generate power.

The heat recovery steam generator 20 generates steam by exchanging heat between the exhaust gas discharged from the turbine 63 in the gas turbine 17 and the water supplied to the heat recovery steam generator 20, and supplies the generated steam to the steam turbine 18. In the steam turbine 18, the turbine 69 is rotationally driven by the steam supplied from the heat recovery steam generator 20 to rotationally drive the generator 19 through the rotary shaft 64, which makes it possible to generate power. In addition, the gas turbine 17 and the steam turbine 18 do not have to use the same shaft to rotationally drive one generator 19, but may use separate shafts to rotationally drive a plurality of generators.

After then, the nitrogen oxides (NOX) of the exhaust gas discharged from the gas turbine 17 are removed by the SCR (Selective Catalytic Reduction) in the heat recovery steam generator 20, and the purified exhaust gas is discharged into the atmosphere from the stack 75.

### (Gasification Unit)

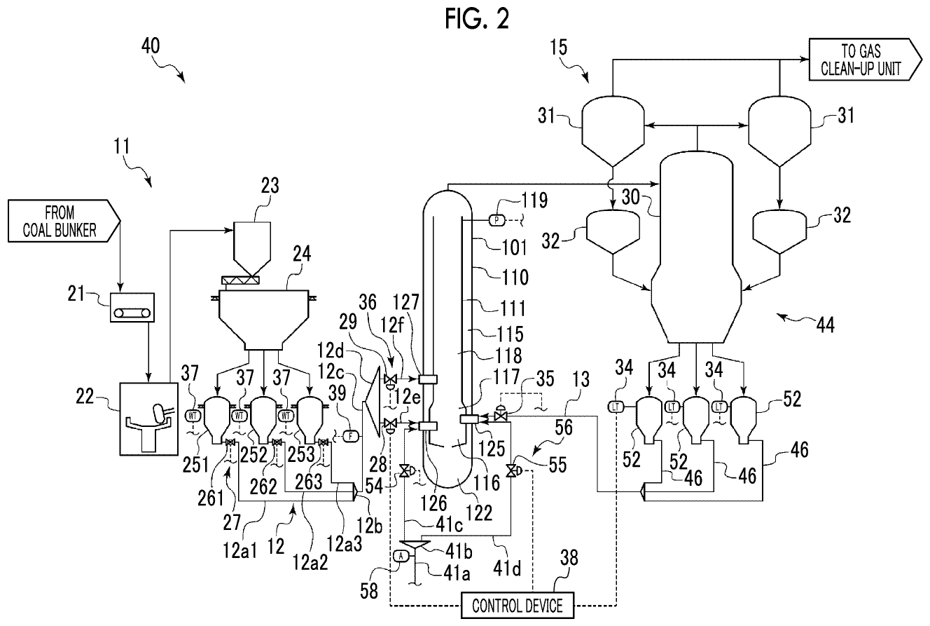

FIG. 2 is a diagram showing an example of the configuration of the gasifier 101 and the surroundings thereof in the integrated coal gasification combined cycle 10 shown in FIG. 1, and shows the gasification unit 40 according to the embodiment. As shown in FIG. 2, the integrated coal gasification combined cycle 10 includes a control device 38 together with the above-described coal feeding unit 11, the gasifier 101, and the char recovery unit 15, and the coal feeding unit 11, the gasifier 101, the char recovery unit 15, and the control device 38 configure the gasification unit 40. Hereinafter, each configuration of the gasification unit 40 shown in FIG. 2 will be described.

### (Coal Feeding Unit)

As shown in FIG. 2, the coal feeding unit 11 includes a coal feeder 21, a coal pulverizer 22, a pulverized coal collector 23, a pulverized coal bin 24, and a plurality of pulverized coal feed hoppers 251 to 253 (a plurality of fuel feed hoppers).

The coal is supplied from a coal bunker to the coal pulverizer 22 by a coal feeder 21. The coal is pulverized and dried by the coal pulverizer 22 to become pulverized coal, and is transported to the pulverized coal collector 23 by air flow transport, and is collected and temporarily stored in the pulverized coal bin 24.

In the example shown in the drawing, the plurality of pulverized coal feed hoppers 251 to 253 include three pulverized coal feed hoppers 251, 252, and 253 connected to the pulverized coal bin 24, and the pulverized coal is supplied from the pulverized coal bin 24 by utilizing a pressure difference with the pulverized coal bin 24. Each of the three pulverized coal feed hoppers 251, 252, and 253 is configured to be able to supply the pulverized coal to the gasifier 101 via the fuel supply line 12 by using a pressure difference with the gasifier 101. Each of the plurality of pulverized coal feed hoppers 251 to 253 is provided with storage amount measurement equipment 37 that measures the storage amount of the pulverized coal. The storage amount measurement equipment 37 may measure the storage amount of the pulverized coal by a load sensor such as a load cell, or may measure the storage amount of the pulverized coal by another known method.

### (Gasifier)

As shown in FIG. 2, the gasifier 101 is formed to extend in the vertical direction. The pulverized coal and oxygen are supplied to the lower side in the vertical direction. The raw syngas which has been partially combusted and gasified is circulated from the lower side to the upper side in the vertical direction. The gasifier 101 has a pressure vessel 110 and a gasifier wall (furnace wall) 111 provided inside the pressure vessel 110.

Then, the gasifier 101 forms an annular portion 115 in a space between the pressure vessel 110 and the gasifier wall 111. In addition, the gasifier 101 forms a combustor part 116, a diffuser part 117, and a reductor part 118 in the order from the lower side in the vertical direction (that is, the upstream side in the circulation direction of the raw syngas) in a space 154 inside the gasifier wall 111.

The pressure vessel 110 is formed in a tubular shape with a hollow space inside, and a gas discharge port is formed in an upper end portion thereof, while a slag bath 122 is formed in a lower end portion (bottom portion) thereof. The gasifier wall 111 is formed in a tubular shape with a hollow space inside, and the outer wall surface thereof is provided to face the inner wall surface of the pressure vessel 110.

The gasifier wall 111 separates the inside of the pressure vessel 110 into the internal space 154 and the external space (annular portion 115). The cross-sectional shape of the gasifier wall 111 is a shape that changes at the diffuser part 117 between the combustor part 116 and the reductor part 118. An upper end portion of the gasifier wall 111 that is on a vertically upper side is connected to a gas discharge port of the pressure vessel 110, and a lower end portion of the gasifier wall 111 that is on a vertically lower side is provided with a gap from the bottom portion of the pressure vessel 110. Stored water is stored in the slag bath 122 formed at the bottom portion of the pressure vessel 110, and the lower end portion of the gasifier wall 111 is submerged in the stored water, thereby sealing the inside and outside of the gasifier wall 111. Various burners are inserted into the gasifier wall 111.

In the present embodiment, in the combustor part 116, for example, a plurality of char burners 125, a plurality of combustor system pulverized coal burners (burners) 126 are provided in order from the upper side of the furnace on the gasifier wall 111 in the combustor part 116, and a combustion device consisting of a plurality of slag melting burners, an ignition torch, and a light oil burner (not shown) is disposed in the startup combustion chamber located below the combustor. The slag melting burner is for melting the generated solidified slag. A tip of the slag melting burner is used to melt and remove the solidified slag. The plurality of ignition torches and the light oil burners are used for starting the gasifier 101. The high-temperature combustion gas obtained by combusting a part of the pulverized coal and char by the combustor part 116 passes through the diffuser part 117 and flows into the reductor part 118.

The reductor part 118 is a space where pulverized coal is supplied to the combustion gas from the combustor part 116, which is maintained at a high temperature required for the gasification reaction, and partial oxidation combustion is carried out to gasify and decompose the pulverized coal to produce a raw syngas which is a volatile matter (carbon monoxide, hydrogen, lower hydrocarbons, and the like), and a combustion device consisting of a plurality of reductor system pulverized coal burners (burners) 127 is disposed on the gasifier wall 111 in the reductor part 118.

The gasifier 101 is provided with a pressure sensor 119 for measuring a pressure (in the example shown in the drawing, a pressure inside the gasifier wall 111) inside the gasifier 101.

### (Fuel Supply Line)

As shown in FIG. 2, the fuel supply line 12 includes a plurality of upstream fuel line portions 12a1 to 12a3, a branching portion 12b, an intermediate line portion 12c, a branching portion 12d, a combustor side fuel line portion 12e, and a reductor side fuel line portion 12f.

Upstream ends of the plurality of upstream fuel line portions 12a1, 12a2, and 12a3 are connected to the plurality of pulverized coal feed hoppers 251, 252, and 253, respectively. Downstream ends of the plurality of upstream fuel line portions 12a1, 12a2, and 12a3 are connected to an upstream end of the intermediate line portion 12c via the branching portion 12b. A downstream end of the intermediate line portion 12c is connected to an upstream end of the combustor side fuel line portion 12e and an upstream end of the reductor side fuel line portion 12f via a branching portion 12d.

The upstream fuel line portion 12al is provided with a discharge valve 261 for adjusting the amount of the pulverized coal discharged from the pulverized coal feed hopper 251, the upstream fuel line portion 12a2 is provided with a discharge valve 262 for adjusting the amount of the pulverized coal discharged from the pulverized coal feed hopper 252, and the upstream fuel line portion 12a3 is provided with a discharge valve 263 for adjusting the amount of the pulverized coal discharged from the pulverized coal feed hopper 253.

The plurality of discharge valves 261 to 263 configure a switching device 27 capable of switching the pulverized coal feed hoppers 251 to 253 for supplying the pulverized coal to the gasifier 101. The switching device 27 is configured to switch the pulverized coal feed hoppers 251 to 253 that supply the pulverized coal to the gasifier 101 by switching the opening/closing states of the plurality of discharge valves 261 to 263 based on a switching command Sc from the control device 38 to be described later and allowing only the selected pulverized coal feed hopper among the plurality of pulverized coal feed hoppers 251 to 253 to communicate with the gasifier 101.

The intermediate line portion 12c is provided with a flow meter 39 for measuring a fuel flow rate F, which is the flow rate of the pulverized coal supplied from the fuel supply line 12 to the gasifier 101.

The combustor side fuel line portion 12e is provided with a fuel flow regulation valve 28 capable of adjusting the flow rate of the pulverized coal supplied from the fuel supply line 12 to the combustor part 116 via the combustor system pulverized coal burner 126. The reductor side fuel line portion 12f is provided with a fuel flow regulation valve 29 capable of adjusting the flow rate of the pulverized coal supplied from the fuel supply line 12 to the reductor part 118 via the reductor system pulverized coal burner 127. The fuel flow regulation valve 28 and the fuel flow regulation valve 29 configure a fuel flow rate adjusting device 36 for adjusting the fuel flow rate F (the amount of pulverized coal supplied to the gasifier 101) of the fuel supplied from the fuel supply line 12 to the gasifier 101.

The pulverized coal passing through the combustor side fuel line portion 12e is supplied to the combustor part 116 of the gasifier 101 via the plurality of combustor system pulverized coal burners 126. The pulverized coal passing through the reductor side fuel line portion 12f is supplied to the reductor part 118 of the gasifier 101 via the plurality of reductor system pulverized coal burners 127.

### (Compressed Air Supply Line)

As shown in FIG. 2, the compressed air supply line 41 includes an upstream air line portion 41a, a branching portion 41b, a combustor side air line portion 41c, and a char supply side air line portion 41d.

A downstream end of the upstream air line portion 41a is connected to an upstream end of the combustor side air line portion 41c and an upstream end of the char supply side air line portion 41d via a branching portion 41b, and a downstream end of the combustor side air line portion 41c is connected to the combustor system pulverized coal burner 126. A downstream end of the char supply side air line portion 41d is connected to the char burner 125.

The pulverized coal supplied from the combustor side fuel line portion 12e to the combustor system pulverized coal burner 126 is mixed with the air supplied from the combustor side air line portion 41c and partially combusted in the combustor part 116. The char supplied from the char supply line 13 to the char burner 125 is partially combusted in the combustor part 116 by being mixed with the air supplied from the char supply side air line portion 41d.

The combustor side air line portion 41c is provided with an air flow regulation valve 54 (oxygen containing gas flow regulation valve) capable of adjusting the flow rate of the air (oxygen containing gas) supplied from the compressed air supply line 41 to the combustor part 116 via the combustor system pulverized coal burner 126. The char supply side air line portion 41d is provided with an air flow regulation valve 55 (oxygen containing gas flow regulation valve) capable of adjusting the flow rate of the air (oxygen containing gas) supplied from the compressed air supply line 41 to the combustor part 116 via the char burner 125. The air flow regulation valve 54 and the air flow regulation valve 55 configure an air flow rate adjusting device 56 for adjusting an air flow rate A which is a flow rate of the air supplied from the compressed air supply line 41 to the gasifier 101 (an amount of the oxygen containing gas supplied to the gasifier).

The upstream air line portion 41a is provided with a flow meter 58 for measuring the air flow rate A which is a flow rate of the air supplied from the compressed air supply line 41 to the gasifier 101.

### (Char Recovery Unit)

As shown in FIG. 2, in the example shown in the drawing, the char recovery unit 15 includes a char cyclone 30, a plurality of porous filters 31 disposed in parallel on the downstream side of the gas flow of the char cyclone 30, a plurality of lower hoppers 32 respectively disposed on the downstream side of the plurality of porous filters 31, and a plurality of char supply hoppers 52 for storing the char discharged from the bottom portion of the char cyclone 30. The char cyclone 30 and the plurality of char supply hoppers 52 configure the char storage portion 44 that stores the char separated from the raw syngas generated in the gasifier 101.

Each of the plurality of char supply hoppers 52 is provided with storage amount measurement equipment 34 for measuring the storage amount of char in the char supply hopper 52. The storage amount measurement equipment 34 may be, for example, a level meter configured to measure a char level, which is a level of the storage amount of char in the char supply hopper 52, by gamma rays, but is not limited thereto, and may be any measurement equipment capable of measuring the storage amount of char.

Each of the plurality of char supply hoppers 52 is connected to the char supply line 13 via the char return line 46, and the char supply line 13 is provided with a char flow regulation valve 35 (char flow rate adjusting device) for adjusting a char flow rate which is a flow rate of the char supplied to the gasifier 101. The char that has passed through the char flow regulation valve 35 in the char supply line 13 is supplied from the plurality of char burners 125 to the gasifier 101.

### (Control Device)

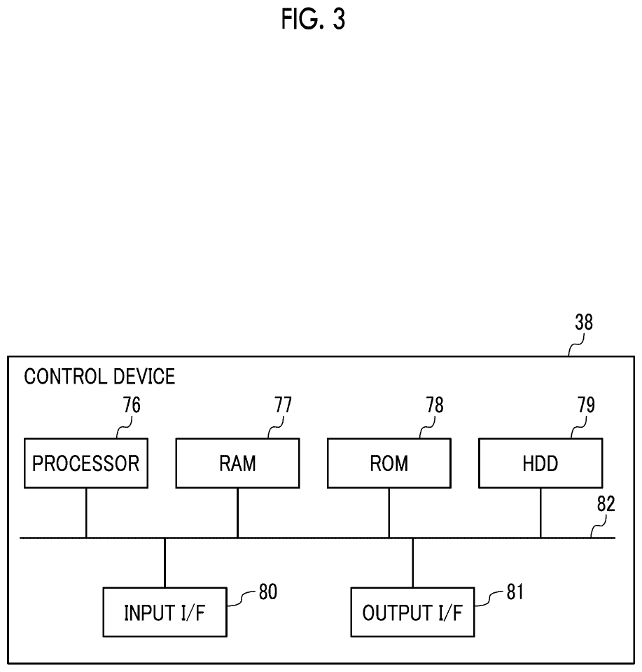

FIG. 3 is a diagram showing an example of a hardware configuration of the control device 38 shown in FIG. 2.

As shown in FIG. 2, the control device 38 is configured using a computer including, for example, a processor 76, a random access memory (RAM) 77, a read only memory (ROM) 78, a hard disk drive (HDD) 79, an input I/F 80, and an output I/F 81 that are connected to each other through a bus 82. In addition, the control device 38 is configured by executing a program for implementing each function of the control device 38 via the computer. Functions of each unit in the control device 38 described below are implemented by loading the program stored in the ROM 78 into the RAM 77 and executing the program via the processor 76 and reading and writing data in the RAM 77 and in the ROM 78. The respective correlation information Fx1 to Fx7 to be described later may be read from, for example, the ROM 78 or the HDD 79 and used for various calculations.

### (Example of Control Circuit of Control Device)

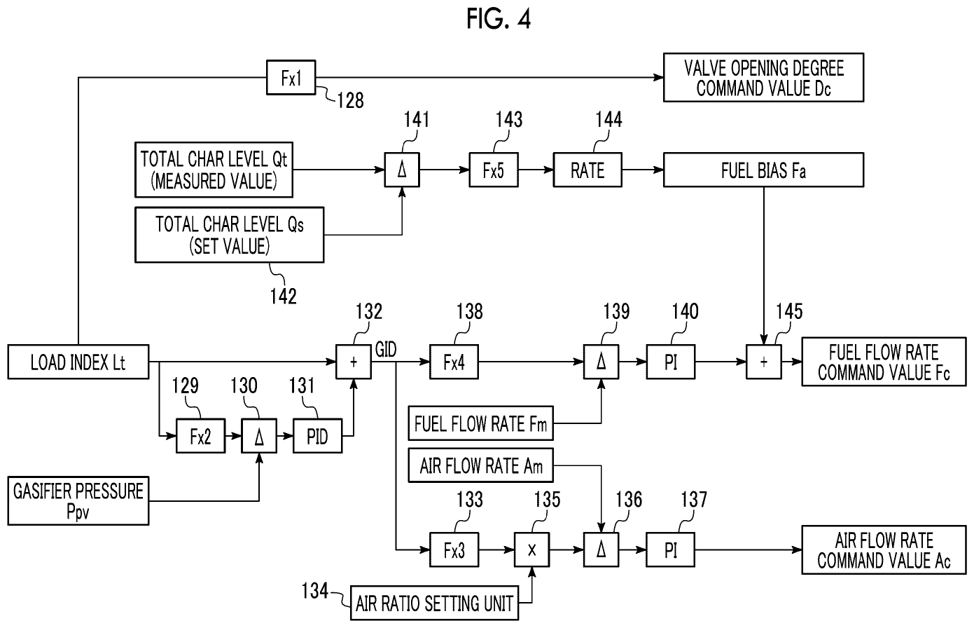

FIG. 4 is a diagram showing an example of the control circuit in the control device 38 shown in FIG. 2.

As shown in FIG. 4, the control device 38 includes a valve opening degree setting unit 128, a gasifier pressure setting unit 129, a subtraction unit 130, a PID control unit 131, an addition unit 132, an air flow rate setting unit 133, an air ratio setting unit 134, a multiplication unit 135, a subtraction unit 136, a PI control unit 137, a fuel flow rate setting unit 138, a subtraction unit 139, a PI control unit 140, a subtraction unit 141, a total char level setting unit 142, a fuel bias calculation unit 143, a gradient setting unit 144, and an addition unit 145.

The valve opening degree setting unit 128 acquires a load index Lt (%) indicating the load of the integrated coal gasification combined cycle 10 (in the example shown in FIG. 1, the total of the load of the gas turbine 17 and the load of the steam turbine 18), and sets a valve opening degree command value Dc of the char flow regulation valve 35 based on the acquired load index Lt and the load valve opening degree correlation information Fx1 indicating the relationship between the load index Lt and the valve opening degree command value Dc of the char flow regulation valve 35 (command value of the valve opening degree of the char flow regulation valve 35). The control device 38 controls the valve opening degree of the char flow regulation valve 35 based on the valve opening degree command value Dc set by the valve opening degree setting unit 128.

The gasifier pressure setting unit 129 acquires the above load index Lt, and sets a target value Psv of the pressure of the gasifier 101, based on the acquired load index Lt and load gasifier pressure correlation information Fx2 indicating the relationship between the load index Lt and the target value Psv of the pressure of the gasifier 101.

The subtraction unit 130 calculates the deviation ΔP (=Ppv−Psv) of the pressure Ppv of the gasifier 101 measured by the pressure sensor 119 with respect to the target value Psv set by the gasifier pressure setting unit 129.

The PID control unit 131 calculates an added value La (%) to be added to the load index Lt, based on the deviation ΔP calculated by the subtraction unit 130.

The addition unit 132 calculates a load GID (%) of the gasifier 101 by adding the added value La (%) calculated by the PID control unit 131 to the load index Lt (%).

The air flow rate setting unit 133 sets the air flow rate A based on the load GID calculated by the addition unit 132 and load air flow rate correlation information Fx3 indicating the relationship between the load GID and the air flow rate A which is the flow rate of the air supplied to the gasifier 101.

The multiplication unit 135 calculates a target value As of the air flow rate A by multiplying the air flow rate A set by the air flow rate setting unit 133 and an air ratio m set by the air ratio setting unit 134.

The subtraction unit 136 calculates a deviation ΔA (=Am−As) of a measured value Am of the air flow rate A measured by the flow meter 58 with respect to the target value As of the air flow rate A calculated by the multiplication unit 135.

The PI control unit 137 calculates the air flow rate command value Ac, which is the command value of the air flow rate A, based on the deviation ΔA calculated by the subtraction unit 136. The control device 38 controls the air flow rate adjusting device 56 based on the air flow rate command value Ac calculated by the PI control unit 137. For example, the control device 38 may control the valve opening degree of the air flow regulation valve 54 based on the air flow rate obtained by multiplying the air flow rate indicated by the air flow rate command value Ac by a predetermined ratio r1 of less than 1, and may control the valve opening degree of the air flow regulation valve 55 based on the air flow rate obtained by multiplying the air flow rate indicated by the air flow rate command value Ac by a predetermined ratio r2 of less than 1 (for example, r2=1−r1).

The fuel flow rate setting unit 138 sets a target value Fs of the fuel flow rate based on the load GID calculated by the addition unit 132 and load fuel flow rate correlation information Fx4 indicating the relationship between the load GID and the target value Fs of the fuel flow rate F which is the flow rate of the pulverized coal supplied to the gasifier 101.

The subtraction unit 139 calculates a deviation ΔF (=Fm−Fs) of a measured value Fm of the fuel flow rate F measured by the flow meter 39 with respect to the target value Fs of the fuel flow rate set by the fuel flow rate setting unit 138.

The PI control unit 140 calculates a provisional value Fp of the command value of the fuel flow rate F, based on the deviation ΔF calculated by the subtraction unit 139.

The subtraction unit 141 calculates a deviation ΔQ (=Qt−Qs) of the measured value Qt of the total char level from a set value Qs of the total char level with respect to the total char level indicating the storage amount of char in the char storage portion 44.

In addition, the total char level Qt may be the total of the storage amount of all the char supply hoppers 52 measured by the plurality of storage amount measurement equipment 34 in a case where the char is not stored in the char cyclone 30, or may be the amount obtained by adding the storage amount of char in the char cyclone 30 to the total storage amount of char in all the char supply hoppers 52 measured by the plurality of storage amount measurement equipment 34 in a case where the char is stored in the char cyclone 30. In this case, for example, the storage amount of char in the char cyclone 30 may be measured by providing storage amount measurement equipment in the char cyclone 30 and measuring the storage amount by the storage amount measurement equipment, or may be measured (estimated) based on the operation time of the gasifier 101 from the timing when the storage amount of char in all the char supply hoppers 52 becomes full. In addition, the total char level Qs is a desirable reference level of the storage amount of char in the char storage portion 44, and is a set value set by the total char level setting unit 142. In addition, the total char level Qt used for calculating the deviation ΔQ in the subtraction unit 141 may be a moving average of the measured values of the total char level.

The fuel bias calculation unit 143 calculates a fuel bias Fa based on the deviation ΔQ calculated by the subtraction unit 141 and fuel bias correlation information Fx5 indicating the relationship between the deviation ΔQ and the fuel bias Fa (value to be added to the above provisional value Fp of the fuel flow rate F). The fuel bias Fa is a variable having a negative correlation to the deviation ΔQ, and the fuel bias Fa calculated by the fuel bias calculation unit 143 decreases as the deviation ΔQ increases, and increases as the deviation ΔQ decreases.

The gradient setting unit 144 restricts (adjusts) the fuel bias Fa calculated by the fuel bias calculation unit 143 to a gradient determined in advance as a fuel bias gradient (%/min) that is a change amount of the fuel bias per unit time.

The addition unit 145 calculates the command value Fc of the fuel flow rate by adding the fuel bias Fa adjusted by the gradient setting unit 144 to the provisional value Fp of the fuel flow rate F calculated by the PI control unit 140. The control device 38 controls the fuel flow rate adjusting device 36 based on the command value Fc of the fuel flow rate calculated by the addition unit 145. For example, the control device 38 may control the valve opening degree of the fuel flow regulation valve 28 based on the fuel flow rate obtained by multiplying the fuel flow rate indicated by the fuel flow rate command value Fc by a predetermined ratio r3 of less than 1, and may control the valve opening degree of the fuel flow regulation valve 29 based on the fuel flow rate obtained by multiplying the fuel flow rate indicated by the fuel flow rate command value Fc by a predetermined ratio r4 of less than 1 (for example, r4=1−r3).

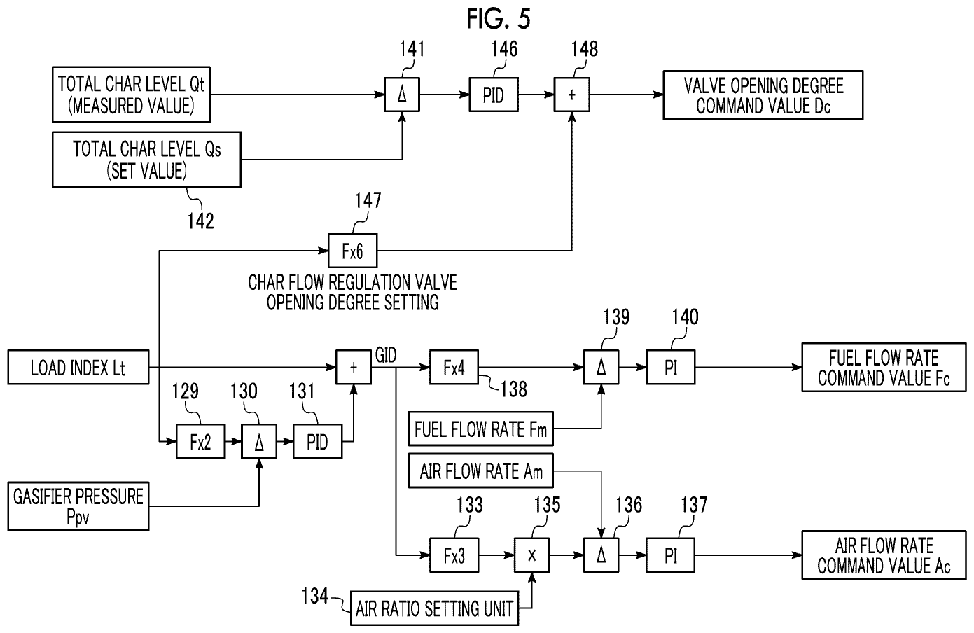

Hereinafter, the effect of the control of the gasifier 101 by the control device 38 shown in FIG. 4 will be described in comparison with the control according to the comparative embodiment shown in FIG. 5.

First, a control circuit shown in FIG. 5 will be described. In the control circuit shown in FIG. 5, the same functional units as the functional units shown in FIG. 4 will be denoted by the same reference numerals, and the description thereof will be omitted.

In the control circuit shown in FIG. 5, the PID control unit 146 is configured to perform feedback control of operating the valve opening degree of the char flow regulation valve 35 based on the deviation ΔQ between the measured value Qt of the total char level and the set value Qs of the total char level. The valve opening degree setting unit 147 sets the valve opening degree of the char flow regulation valve 35, based on the load index L and valve opening degree correlation information Fx6 indicating the relationship between the load index L and the valve opening degree of the char flow regulation valve 35. The PID control unit 146 calculates an added value for addition to the valve opening degree of the char flow regulation valve 35 according to the deviation ΔQ. The addition unit 148 calculates a command value of the valve opening degree of the char flow regulation valve 35 by adding the added value calculated by the PID control unit 146 to the valve opening degree of the char flow regulation valve 35 set by the valve opening degree setting unit 147, and the control device 38 controls the valve opening degree of the char flow regulation valve 35 based on the command value of the valve opening degree of the char flow regulation valve calculated by the addition unit 148.

In the control circuit shown in FIG. 5, feedforward control using the valve opening degree of the char flow regulation valve 35 determined according to the load index L is performed, and the valve opening degree of the char flow regulation valve 35 is adjusted to maintain the total char level constant, thereby performing the fixed value control (feedback control) for controlling the flow rate of the char supplied to the gasifier 101.

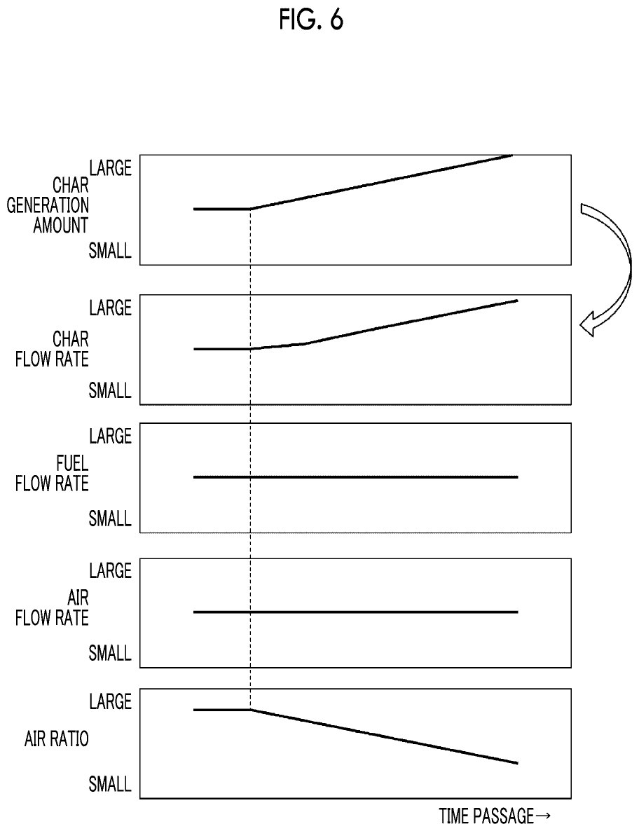

FIG. 6 is a diagram showing a time change in each of the char flow rate (the amount of char fed to the gasifier 101), the fuel flow rate, the air flow rate, and the air ratio in a case where the amount of char generated in the gasifier 101 increases with the passage of time due to a change in the properties of the pulverized coal or the like when the control shown in FIG. 5 is performed under the condition where the load index L is constant.

As shown in FIG. 6, in the above-described comparative embodiment, in a case where the amount of char generated in the gasifier 101 increases due to the variation in the properties of the coal (moisture content or the like) or the like, the total char level increases according to the increase in the amount of char generated. Therefore, the control device operates the char flow regulation valve 35 in the opening direction to make the total char level constant, and the flow rate of the char to the gasifier 101 increases with the passage of time. On the other hand, the fuel flow rate and the air flow rate are controlled to a constant value determined according to the load index L. For this reason, the air ratio of the gasifier 101 decreases as the char flow rate increases, which causes the amount of char generated in the gasifier 101 to further increase. In addition, although not shown, in a case where the amount of char generated in the gasifier 101 decreases due to variations in the properties of the coal (moisture content or the like) or the like, the total char level decreases according to the decrease in the amount of char generated. Therefore, the control device operates the char flow regulation valve 35 in the closing direction to make the total char level constant, and the flow rate of the char to the gasifier 101 decreases with the passage of time. On the other hand, the fuel flow rate and the air flow rate are controlled to a constant value determined according to the load index L. For this reason, the air ratio of the gasifier 101 increases as the char flow rate decreases, which causes the amount of char generated in the gasifier 101 to further decrease.

As described above, in the comparative embodiment, when the amount of char generated in the gasifier 101 fluctuates due to the variation in the properties of the coal or the like, the air ratio and the total char level cannot be appropriately controlled, and there is a possibility that the gasification efficiency of the gasifier may decrease or the total char level may diverge. In addition, since it is difficult to detect a change in the properties of the coal in real time, changes in the properties of coal are not noticed until the amount of char generated in the gasifier 101 changes significantly, making it difficult to take appropriate measures.

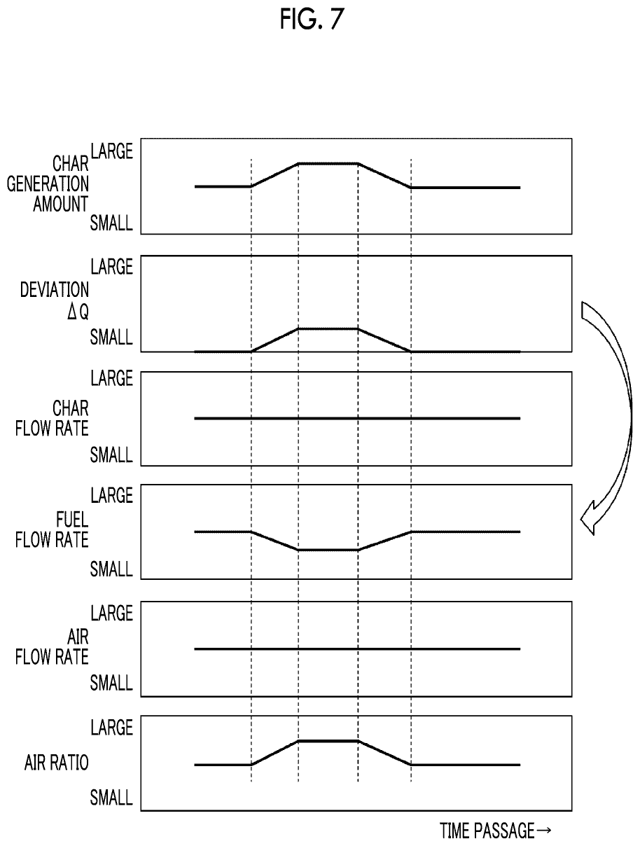

FIG. 7 is a diagram showing a time change in each of the deviation ΔQ, the char flow rate, the fuel flow rate, the air flow rate, and the air ratio in a case where the amount of char generated in the gasifier 101 increases with the passage of time due to a change in the properties of the pulverized coal or the like when the control shown in FIG. 4 is performed under a condition where the load index L is constant.

As shown in FIG. 7, in the above embodiment, in a case where the amount of char generated in the gasifier 101 increases due to variations in the properties of the coal or the like, the deviation ΔQ of the total char level increases. However, the fuel flow rate is reduced (that is, a negative fuel bias is added) to match the deviation ΔQ, and the bias control in which a negative fuel bias is added to the fuel flow rate until the deviation ΔQ of the total char level disappears is performed. In this case, the flow rate of the char and the air flow rate to the gasifier 101 are controlled to a constant amount determined according to the load. In addition, in a case where the amount of char generated in the gasifier 101 is reduced, the control opposite to the above control, that is, the bias control is performed in which the fuel flow rate is increased (that is, the positive fuel bias is added) to match the deviation ΔQ and the positive fuel bias is added to the fuel flow rate until the deviation ΔQ of the total char level disappears.

As shown in FIG. 7, in the above embodiment, even when the amount of char generated in the gasifier 101 changes due to variations in the properties of coal or the like, the char flow rate to the gasifier is controlled to a constant amount according to the load index L. Therefore, the char flow rate can be stabilized to an appropriate amount. In addition, even when the amount of char generated in the gasifier 101 changes, the fuel bias corresponding to the deviation ΔQ of the total char level is added to the fuel flow rate determined according to the load index L, and accordingly, the air ratio of the gasifier 101 can be stabilized, and the stable operation of the gasifier can be realized.

### Another Example of Control Circuit of Control Device

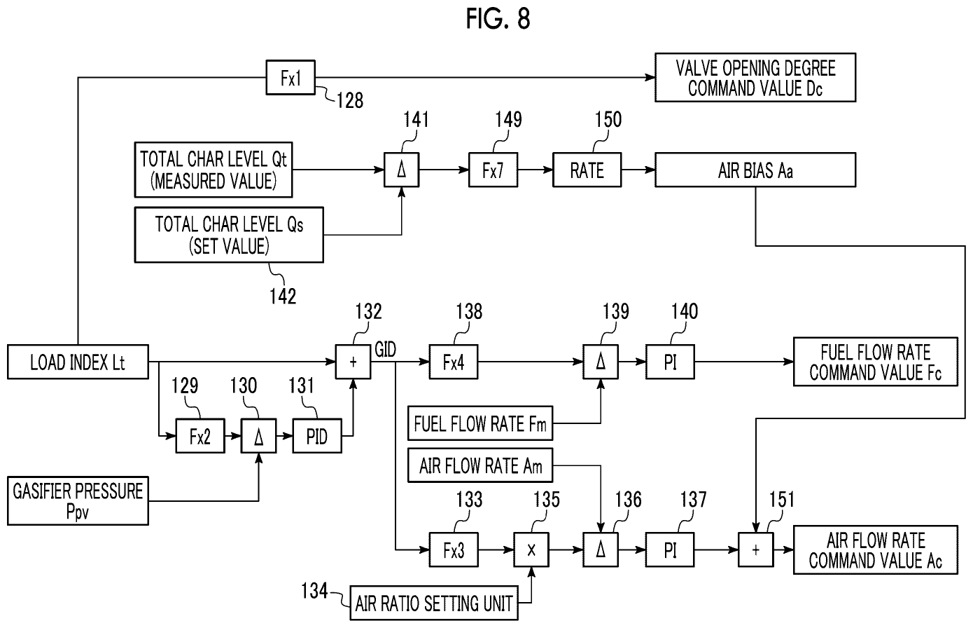

FIG. 8 is a diagram showing another example of the control circuit in the control device 38 shown in FIG. 2.

In the control circuit shown in FIG. 8, the same reference numerals as those of the control circuit shown in FIG. 4 denote the same configurations as those of the control circuit shown in FIG. 4 unless otherwise specified, and the description thereof will be omitted.

The control circuit shown in FIG. 8 includes an air bias calculation unit 149, a gradient setting unit 150, and an addition unit 151 instead of the fuel bias calculation unit 143, the gradient setting unit 144, and the addition unit 145 in the control circuit shown in FIG. 4.

The PI control unit 137 calculates a provisional value Ap of the command value of the air flow rate A, based on the deviation ΔA calculated by the subtraction unit 136.

The PI control unit 140 sets the fuel flow rate command value Fc, which is the command value of the fuel flow rate F, based on the deviation ΔF calculated by the subtraction unit 139. The control device 38 controls the fuel flow rate adjusting device 36 based on the fuel flow rate command value Fc set by the PI control unit 140. For example, the control device 38 may control the valve opening degree of the fuel flow regulation valve 28 based on the fuel flow rate obtained by multiplying the fuel flow rate indicated by the fuel flow rate command value Fc by a predetermined ratio r3 of less than 1, and may control the valve opening degree of the fuel flow regulation valve 29 based on the fuel flow rate obtained by multiplying the fuel flow rate indicated by the fuel flow rate command value Fc by a predetermined ratio r4 of less than 1 (for example, r4=1−r3).

The air bias calculation unit 149 calculates the air bias Aa based on the deviation ΔQ calculated by the subtraction unit 141 and air bias correlation information Fx7 indicating the relationship between the deviation ΔQ and the air bias Aa (value added to the provisional value Ap of the air flow rate A). The air bias Aa is a variable having a positive correlation to the deviation ΔQ, and the air bias Aa calculated by the air bias calculation unit 149 increases as the deviation ΔQ increases and decreases as the deviation ΔQ decreases.

The gradient setting unit 150 restricts (adjusts) the air bias Aa calculated by the air bias calculation unit 149 to a gradient determined in advance as an air bias gradient (%/min) that is a change amount of the air bias per unit time.

The addition unit 151 calculates the command value Ac of the air flow rate by adding the air bias Aa adjusted by the gradient setting unit 150 to the provisional value Ap of the command value of the air flow rate A calculated by the PI control unit 137. The control device 38 controls the air flow rate adjusting device 56 based on the command value Ac of the air flow rate calculated by the addition unit 151. For example, the control device 38 may control the valve opening degree of the air flow regulation valve 54 based on the air flow rate obtained by multiplying the air flow rate indicated by the air flow rate command value Ac by a predetermined ratio r1 of less than 1, and may control the valve opening degree of the air flow regulation valve 55 based on the air flow rate obtained by multiplying the air flow rate indicated by the air flow rate command value Ac by a predetermined ratio r2 of less than 1 (for example, r2=1-r1).

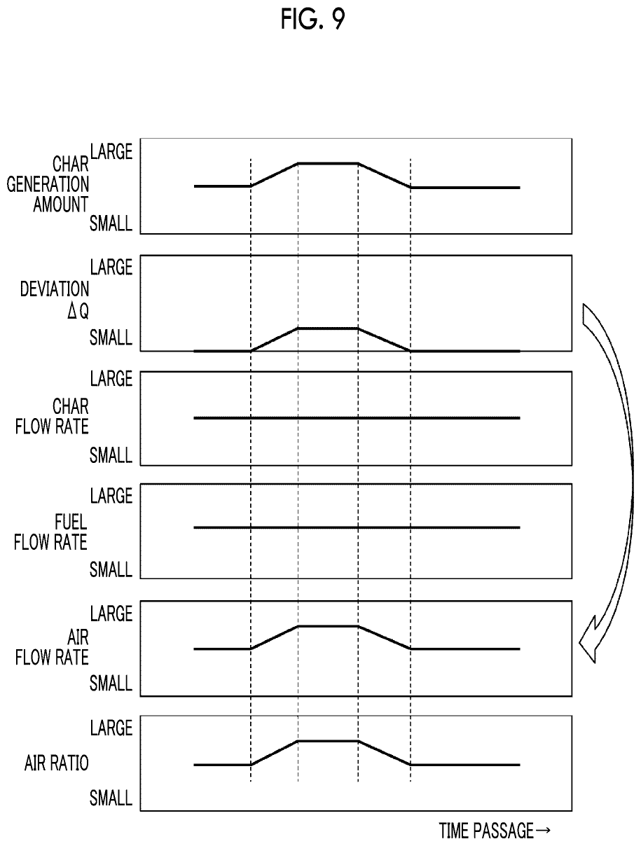

FIG. 9 is a diagram showing a time change in each of the deviation ΔQ, the char flow rate, the fuel flow rate, the air flow rate, and the air ratio in a case where the amount of char generated in the gasifier 101 increases with the passage of time due to a change in the properties of the pulverized coal or the like when the control shown in FIG. 8 is performed under a condition where the load index L is constant.

As shown in FIG. 9, in the above embodiment, in a case where the amount of char generated in the gasifier 101 increases due to variations in the properties of the coal or the like, the deviation ΔQ of the total char level increases. However, the air flow rate is increased (that is, a positive air bias Aa is added) to match the deviation ΔQ, and the bias control in which a positive fuel bias Aa is added to the air flow rate until the deviation ΔQ of the total char level disappears is performed. In this case, the flow rate of the char and the fuel flow rate to the gasifier 101 are controlled to a constant amount determined according to the load. In a case where the amount of char generated in the gasifier 101 is reduced, the bias control is performed in which the control opposite to the above control, that is, the air flow rate is reduced to match the deviation ΔQ (that is, a negative air bias Aa is added) and the negative air bias Aa is added to the air flow rate until the deviation ΔQ of the total char level disappears.

As shown in FIG. 9, in the above embodiment, even when the amount of char generated in the gasifier 101 increases due to variations in the properties of coal or the like, the char flow rate to the gasifier is controlled to a constant amount according to the load index L. Therefore, the char flow rate can be stabilized to an appropriate amount. In addition, even when the amount of char generated in the gasifier 101 increases, the air bias Aa corresponding to the deviation ΔQ of the total char level is added to the air flow rate determined according to the load index L, and accordingly, the air ratio of the gasifier 101 can be stabilized, and the gasifier can be stably operated.

### Still Another Example of Control Circuit of Control Device

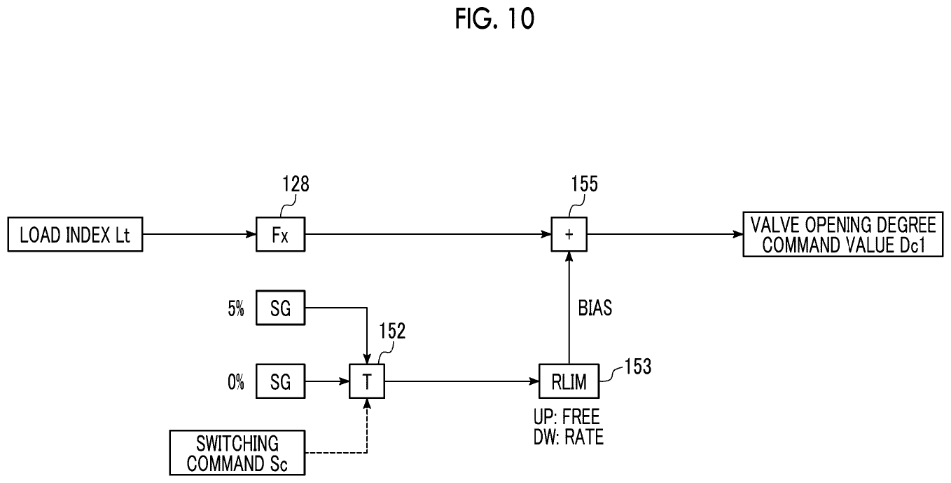

In some embodiments, for example, the control device 38 shown in FIG. 4 or FIG. 8 may be configured to temporarily increase the char flow rate to the gasifier 101 in a case where the switching command Sc for switching the pulverized coal feed hoppers 251 to 253 that supply the pulverized coal to the gasifier 101 is generated, as shown in FIG. 10.

In the example shown in FIG. 10, the control device 38 further includes a switching unit 152, a gradient setting unit 153, and an addition unit 155 in addition to the configuration shown in FIG. 4 or 8.

The switching unit 152 is configured to be able to switch the value of a valve opening degree bias Da, which is a variable added to the valve opening degree of the char flow regulation valve 35, between 0% and a predetermined positive value (5% in the example shown in the drawing).

In a case where the switching command Sc for switching the pulverized coal feed hoppers 251 to 253 for supplying the pulverized coal to the gasifier 101 is not generated, the switching unit 152 selects 0% as the value of the valve opening degree bias Da. In a case where the switching command Sc for switching the pulverized coal feed hoppers 251 to 253 that supply the pulverized coal to the gasifier 101 is generated, the switching unit 152 selects the predetermined value (5%) as the value of the valve opening degree bias Da.

In addition, the switching command Sc for switching the pulverized coal feed hoppers 251 to 253 that supply the pulverized coal to the gasifier 101 may be generated by the control device 38 based on the measurement results of the storage amount measurement equipment 37 provided in each of the pulverized coal feed hoppers 251 to 253. For example, in a case where the pulverized coal is supplied from the pulverized coal feed hopper 251 to the gasifier 101, that is, in a case where the discharge valve 261 is in an open state and the discharge valve 262 and the discharge valve 263 are in a closed state, in a case where the amount of stored pulverized coal measured by the storage amount measurement equipment 37 provided in the pulverized coal feed hopper 251 falls below a predetermined level, the control device 38 may generate the switching command Sc for controlling the discharge valves 261 to 263 such that the pulverized coal feed hopper for supplying the pulverized coal to the gasifier 101 is switched from the pulverized coal feed hopper 251 to the other pulverized coal feed hopper 252 or 253 (the discharge valve 261 is closed and the discharge valve 262 or 263 is opened).

The gradient setting unit 153 restricts (adjusts) the valve opening degree bias gradient (%/min), which is the change amount of the valve opening degree per unit time, to a predetermined gradient for the value (0% or 5%) of the valve opening degree bias Da selected by the switching unit 152.

The addition unit 155 calculates the valve opening degree command value Dc1 of the char flow regulation valve 35 by adding the valve opening degree bias Da of which the gradient is adjusted by the gradient setting unit 153 to the valve opening degree command value Dc of the char flow regulation valve 35 set by the valve opening degree setting unit 128. The control device 38 controls the valve opening degree of the char flow regulation valve 35 based on the valve opening degree command value Dc1 calculated by the addition unit 155.

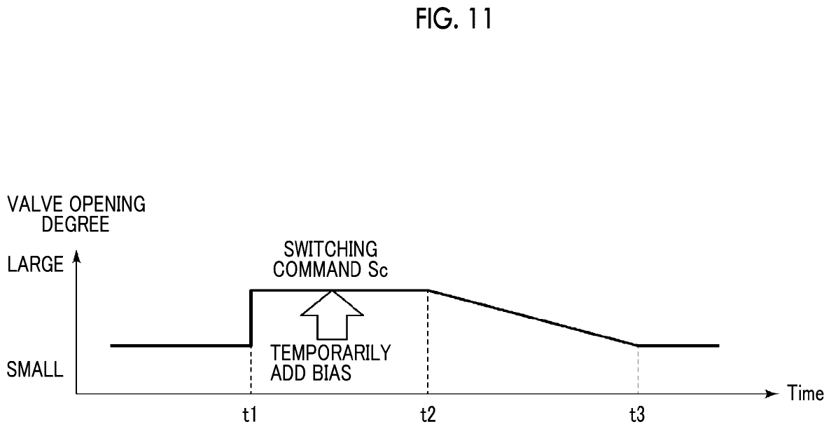

FIG. 11 is a diagram showing an example of the control shown in FIG. 10, and shows a relationship between time and a valve opening degree of the char flow regulation valve 35.

As shown in FIG. 11, at time t1, the switching unit 152 switches the value of the valve opening degree bias Da from 0% to 5% in response to the generation of the switching command Sc for switching the pulverized coal feed hoppers 251 to 253 that supply the pulverized coal to the gasifier 101. In the example shown in FIG. 11, the gradient setting unit 153 is configured not to limit the valve opening degree bias gradient in a case where the valve opening degree of the char flow regulation valve 35 is increased, and the valve opening degree of the char flow regulation valve 35 is increased at the maximum speed to the set opening degree according to the valve opening degree command value Dc1. At time t2, the switching unit 152 switches the value of the valve opening degree bias Da from 5% to 0% in response to the disappearance of the switching command Sc for switching the pulverized coal feed hoppers 251 to 253 for supplying the pulverized coal to the gasifier 101. The gradient setting unit 153 is configured to limit the valve opening degree bias gradient to a predetermined gradient in a case where the valve opening degree of the char flow regulation valve 35 is reduced, and a period from the time t2 to the time t3 when the valve opening degree bias Da becomes 0 is a period in which the valve opening degree bias gradient is limited to the gradient set by the gradient setting unit 153.

Hereinafter, the effects of the control shown in FIGS. 10 and 11 will be described.

In a case where the pulverized coal feed hoppers 251 to 253 for supplying the pulverized coal to the gasifier 101 are switched as described above, the pressure of the gasifier 101 is applied to the fuel supply line 12 up to the position of the outlet of the pulverized coal feed hoppers 251 to 253 (the position of the discharge valves 261 to 263). Therefore, when the flow rate of the pulverized coal to be supplied to the gasifier 101 temporarily fluctuates (decreases) due to the switching of the pulverized coal feed hoppers 251 to 253, there is a concern that a short-term high air ratio operation state may occur in the gasifier 101 and the metal temperature of the gasifier 101 may rise. Therefore, as described above, the valve opening degree bias Da is added to the valve opening degree command value Dc based on the switching command Sc for switching the pulverized coal feed hoppers 251 to 253 for supplying the pulverized coal to the gasifier 101 by the switching device 27, and accordingly, the increase in the air ratio of the gasifier 101 and the increase in the metal temperature can be suppressed, and the operation of the gasifier 101 can be stabilized. In this manner, in a case where it is predicted in advance that the amount of heat input to the gasifier 101 temporarily exceeds or falls short, the control device 38 controls the char flow regulation valve 35 to suppress the occurrence of the excess or insufficiency, and temporarily changes the char flow rate to the gasifier 101, and accordingly, an increase in the air ratio of the gasifier 101 and an increase in the metal temperature can be suppressed, and the operation of the gasifier 101 can be stabilized.

### Other Modification Examples

The present disclosure is not limited to the above-described embodiments, and includes modifications of the above-described embodiments and a combination of these embodiments as appropriate.

For example, in the example shown in FIG. 10, the valve opening degree command value Dc is corrected based on the switching command Sc for switching the pulverized coal feed hoppers 251 to 253 that supply the pulverized coal to the gasifier 101. However, the control device 38 may perform feedforward control in which the valve opening degree command value Dc is corrected based on a leading index Lf indicating a time change rate of the load of the integrated coal gasification combined cycle 10 (in the example shown in FIG. 1, the total of the load of the gas turbine 17 and the load of the steam turbine 18). For example, in a case where the leading index Lf indicates an increase in the load of the integrated coal gasification combined cycle 10, the control device 38 may correct the valve opening degree command value Dc such that the valve opening degree increases with respect to the valve opening degree command value Dc of the char flow regulation valve 35 set by the valve opening degree setting unit 128 (a positive valve opening degree bias Da may be added to the valve opening degree command value Dc). In addition, for example, in a case where the leading index Lf indicates a decrease in the load of the integrated coal gasification combined cycle 10, the control device 38 may correct the valve opening degree command value Dc such that the valve opening degree decreases with respect to the valve opening degree command value Dc of the char flow regulation valve 35 set by the valve opening degree setting unit 128 (a negative valve opening degree bias Da may be added to the valve opening degree command value Dc). As described above, the valve opening degree bias Da which is a variable having a positive correlation to the leading index Lf indicating the time change rate of the load may be added to the valve opening degree command value Dc of the char flow regulation valve 35 set by the valve opening degree setting unit 128.

In this manner, in a case where it is predicted in advance that the amount of heat input to the gasifier 101 temporarily exceeds or falls short, the control device 38 controls the char flow regulation valve 35 to suppress the occurrence of the excess or insufficiency, and temporarily changes the char supply amount, and accordingly, an increase in the air ratio of the gasifier 101 and an increase in the metal temperature can be suppressed, and the operation of the gasifier 101 can be stabilized.

In addition, in the above-described embodiment, the control device 38 configured to adjust the fuel flow rate or the air flow rate based on the total char level indicating the amount of char stored in the char storage portion 44 has been exemplified. However, the control device 38 may adjust both the fuel flow rate and the air flow rate based on the total char level indicating the amount of char stored in the char storage portion 44. In this case, the control device 38 may generate the fuel flow rate command value Fc by adding the above-described fuel bias Fa to the fuel flow rate determined according to the load index Lt, and generate the air flow rate command value Ac by adding the above-described air bias Aa to the air flow rate determined according to the load index Lt. The control device 38 may control at least one of the fuel flow rate adjusting device 36 and the air flow rate adjusting device 56 to adjust at least one of the fuel flow rate and the air flow rate based on the total char level indicating the amount of char stored in the char storage portion 44.

In addition, in the above-described embodiment, the total of the storage amount of char in the char cyclone 30 and the storage amount of char in all the char supply hoppers 52 is used as the total char level Qt. However, the storage amount of char in the char cyclone 30 may not be included in the total char level.

In addition, in the above-described embodiment, the load of the integrated coal gasification combined cycle 10 (in the example shown in FIG. 1, the total of the load of the gas turbine 17 and the load of the steam turbine 18) is given as the load index Lt. However, the load index Lt may be the load of a unit (a unit driven by combustion of the combustible gas) using the combustible gas generated in the gasifier 101, and may be, for example, the load of the gas turbine 17.

For example, contents described in each of the above-described embodiments are understood as follows.

(1) A gasification unit (for example, the above-described gasification unit 40) according to at least one embodiment of the present disclosure includes: a gasifier (for example, the above-described gasifier 101) for generating a combustible gas (for example, the above-described raw syngas) by using a carbonaceous feedstock (for example, the above-described coal) and an oxygen containing gas (for example, the above-described air); a char storage portion (for example, the above-described char storage portion 44) for storing char separated from the combustible gas generated in the gasifier; a char supply line (for example, the above-described char supply line 13) for supplying the char from the char storage portion to the gasifier; a char flow rate adjusting device (for example, the above-described char flow regulation valve 35) provided in the char supply line for adjusting a char flow rate, which is a flow rate of the char supplied to the gasifier; a fuel supply line (for example, the above-described fuel supply line 12) for supplying the carbonaceous feedstock to the gasifier; a fuel flow rate adjusting device (for example, the above-described fuel flow rate adjusting device 36) provided in the fuel supply line for adjusting a fuel flow rate, which is a flow rate of the carbonaceous feedstock supplied to the gasifier; an oxygen containing gas supply line (for example, the above-described compressed air supply line 41) for supplying the oxygen containing gas to the gasifier; an oxygen containing gas flow rate adjusting device (for example, the above-described air flow rate adjusting device 56) provided in the oxygen containing gas supply line for adjusting an oxygen containing gas flow rate, which is a flow rate of the oxygen containing gas supplied to the gasifier; and a control device (for example, the above-described control device 38), and the control device is configured to control the char flow rate adjusting device to control the char flow rate to a flow rate determined according to a load index (for example, the above-described load index Lt) indicating a load of a unit (for example, the above-described integrated coal gasification combined cycle 10) using the combustible gas, and control at least one of the fuel flow rate adjusting device and the oxygen containing gas flow rate adjusting device to adjust at least one of the fuel flow rate and the oxygen containing gas flow rate based on a total char level (for example, the above-described total char level Qt) indicating a storage amount of char in the char storage portion.

According to the gasification unit described in the above (1), even when the amount of char generated in the gasifier changes due to variations in the properties of the carbonaceous feedstock or the like, the char flow rate to the gasifier is controlled to a flow rate determined according to the load. Therefore, the char flow rate can be stabilized to an appropriate amount. In addition, even when the amount of char generated in the gasifier changes, at least one of the fuel flow rate and the oxygen containing gas flow rate is appropriately adjusted according to the total char level, and accordingly, the air ratio of the gasifier can be stabilized, and the stable operation of the gasifier can be realized.

(2) In some embodiments, in the gasification unit according to the above (1), when a deviation of a measured value (for example, the above-described measured value Qt) of the total char level with respect to a set value (for example, the above-described set value Qs) of the total char level is ΔQ, the control device is configured to control at least one of the fuel flow rate adjusting device and the oxygen containing gas flow rate adjusting device such that at least one of the fuel flow rate and the oxygen containing gas flow rate is adjusted according to the deviation ΔQ.

According to the gasification unit of the above (2), even when the amount of char generated in the gasifier changes due to variations in the properties of the carbonaceous feedstock or the like, at least one of the fuel flow rate and the oxygen containing gas flow rate is appropriately adjusted according to the deviation ΔQ of the total char level, and accordingly, the air ratio of the gasifier and the amount of char generated can be stabilized, and the stable operation of the gasifier can be realized.

(3) In some embodiments, in the gasification unit according to the above (2), the control device is configured to generate a fuel flow rate command value (for example, the above-described fuel flow rate command value Fc), which is a command value of the fuel flow rate, by adding a fuel bias (for example, the above-described fuel bias Fa), which is a variable having a negative correlation to the deviation ΔQ, to the fuel flow rate calculated based on the load index, and control the fuel flow rate adjusting device based on the fuel flow rate command value.

According to the gasification unit described in the above (3), even when the amount of char generated in the gasifier changes due to variations in the properties of the carbonaceous feedstock or the like, the fuel flow rate command value is generated by adding the fuel bias, which is a variable having a negative correlation to the deviation ΔQ of the total char level, to the fuel flow rate determined according to the load, and accordingly, the air ratio of the gasifier and the amount of char generated can be stabilized, and the stable operation of the gasifier can be realized.

(4) In some embodiments, in the gasification unit according to the above (2) or (3), the control device is configured to generate an oxygen containing gas flow rate command value (for example, air flow rate command value Ac), which is a command value of the oxygen containing gas flow rate, by adding an oxygen containing gas bias (for example, the above-described air bias Aa), which is a variable having a positive correlation to the deviation ΔQ, to the oxygen containing gas flow rate calculated based on the load index, and control the oxygen containing gas flow rate adjusting device based on the oxygen containing gas flow rate command value.

According to the gasification unit described in the above (4), even when the amount of char generated in the gasifier changes due to variations in the properties of the carbonaceous feedstock or the like, the oxygen containing gas bias, which is a variable having a positive correlation to the deviation ΔQ of the total char level, is added to the oxygen containing gas flow rate determined according to the load to generate the oxygen containing gas flow rate command value, and accordingly, the air ratio of the gasifier and the amount of char generated can be stabilized, and the stable operation of the gasifier can be realized.

(5) In some embodiments, in the gasification unit according to any one of the above (1) to (4), the control device is configured to, in a case where the temporary occurrence of the excess or insufficiency in an amount of the heat input to the gasifier is predicted, control the char flow rate adjusting device to temporarily change the char flow rate to suppress the occurrence of the excess or insufficiency.

According to the gasification unit of the above (5), in a case where it is predicted in advance that a temporary excess or insufficiency of the amount of heat input to the gasifier occurs, the char flow rate is temporarily changed by controlling the char flow rate adjusting device to suppress the occurrence of the excess or insufficiency, and accordingly, the fluctuation in the air ratio and the metal temperature of the gasifier can be suppressed, and the operation of the gasifier can be stabilized.

(6) In some embodiments, in the gasification unit according to the above (5), a plurality of fuel feed hoppers (for example, the above-described pulverized coal feed hoppers 251 to 253) for storing the carbonaceous feedstock; and a switching device (for example, the above-described switching device 27) that is provided in the fuel supply line and is capable of switching the fuel feed hopper that supplies the carbonaceous feedstock to the gasifier in the plurality of fuel feed hoppers, are provided, the char flow rate adjusting device is a char flow regulation valve provided in the char supply line, and the control device is configured to generate a command value (for example, the above-described valve opening degree command value Dc1) of a valve opening degree of the char flow regulation valve set based on the load index by adding a valve opening degree bias (for example, the above-described valve opening degree bias Da) that is a positive value to the valve opening degree in a case where a switching command (for example, the above-described switching command Sc) for causing the switching device to switch the fuel feed hopper that supplies the carbonaceous feedstock to the gasifier is generated, and control the valve opening degree of the char flow regulation valve based on the command value of the valve opening degree.

In a case where the fuel feed hopper for supplying the carbonaceous feedstock to the gasifier is switched, there is a concern that a high air ratio operation state may occur in the gasifier for a short period of time and the metal temperature of the gasifier may rise due to a temporary fluctuation (decrease) in the flow rate of the fuel to be supplied to the gasifier with the switching of the fuel feed hopper. Therefore, as in the above (6), in a case where the switching command for switching the fuel feed hopper is generated, the command value of the valve opening degree is generated by adding the valve opening degree bias that is a positive value to the valve opening degree of the char flow regulation valve, and accordingly, the increase in the air ratio and the metal temperature of the gasifier caused by the switching of the fuel feed hopper can be suppressed, and the operation of the gasifier can be stabilized.

(7) In some embodiments, in the gasification unit according to the above (5), the char flow rate adjusting device is a char flow regulation valve (for example, the above-described char flow regulation valve 35) provided in the char supply line, and the control device is configured to generate a command value (for example, the above-described valve opening degree command value Dc1) of a valve opening degree of the char flow regulation valve set based on the load index by adding a valve opening degree bias (for example, the above-described valve opening degree bias Da), which is a variable having a positive correlation to an index indicating a time change in the load, to the valve opening degree (for example, the above-described valve opening degree Dc), and control the valve opening degree of the char flow regulation valve based on the command value of the valve opening degree.

According to the gasification unit described in the above (7), the command value of the valve opening degree is generated by adding the valve opening degree bias, which is a variable having a positive correlation to the index indicating the time change of the load, to the valve opening degree based on the load index, and accordingly, the fluctuation in the air ratio and the metal temperature of the gasifier caused by the time change of the load can be suppressed, and the operation of the gasifier can be stabilized.

(8) An integrated gasification combined cycle (for example, the above-described integrated coal gasification combined cycle 10) according to at least one embodiment of the present disclosure includes: the gasification unit (for example, the above-described gasification unit 40) according to any one of the above (1) to (7); a gas turbine (for example, the above-described gas turbine 17) that is rotationally driven by combusting at least a part of a raw syngas generated in the gasifier; a steam turbine (for example, the above-described steam turbine 18) that is rotationally driven by steam generated in a heat recovery steam generator that introduces a turbine exhaust gas discharged from the gas turbine; and a generator (for example, the above-described generator 19) that is connected to the gas turbine and/or the steam turbine for rotational driving.

According to the integrated gasification combined cycle described in the above (8), since the gasification unit described in any one of the above (1) to (7) is provided, the operation of the integrated gasification combined cycle can be stabilized.

(9) A control method of a gasifier (for example, the above-described gasifier 101) according to at least one embodiment of the present disclosure includes: a step of controlling a flow rate of char supplied to the gasifier to a flow rate determined according to a load of a unit (for example, the above-described integrated coal gasification combined cycle 10) that uses a combustible gas generated in the gasifier; and a step of adjusting at least one of a flow rate of a carbonaceous feedstock (for example, the above-described coal) to be supplied to the gasifier and a flow rate of an oxygen containing gas (for example, the above-described air) to be supplied to the gasifier according to a total char level (for example, the above-described total char level Qt) indicating a storage amount of char in a char storage portion (for example, the above-described char storage portion 44).

According to the control method for a gasification unit of (9), even when the amount of char generated in the gasifier changes due to variations in the properties of the carbonaceous feedstock or the like, the char flow rate to the gasifier is controlled to the flow rate determined according to the load of the unit using the raw syngas, and accordingly, the flow rate of the char to the gasifier can be stabilized to an appropriate amount. In addition, even when the amount of char generated in the gasifier changes, at least one of the fuel flow rate and the oxygen containing gas flow rate is appropriately adjusted according to the total char level, and accordingly, the air ratio of the gasifier can be stabilized and the operation of the gasifier can be stabilized.

### REFERENCE SIGNS LIST

10 integrated coal gasification combined cycle
11 coal feeding unit
11a coal feed line
12 fuel supply line
12a1, 12a2, 12a3 upstream fuel line portion
12b, 12d branching portion
12c intermediate line portion
12e combustor side fuel line portion
12f reductor side fuel line portion
13 char supply line
15 char recovery unit
16 gas clean-up unit
17 gas turbine
18 steam turbine
19 generator
20 heat recovery steam generator
21 coal feeder
22 coal pulverizer
23 pulverized coal collector
24 pulverized coal bin
27 switching device
28, 29 fuel flow regulation valve
30 char cyclone
31 porous filter
32 lower hopper
34, 37 storage amount measurement equipment
35 char flow regulation valve (char flow rate adjusting device)
36 fuel flow rate adjusting device
38 control device
39, 58 flow meter
40 gasification unit
41 compressed air supply line
41a upstream air line portion
41b branching portion
41c combustor side air line portion
41d char supply side air line portion
42 air separation unit
43 first nitrogen supply line
44 char storage portion
45 second nitrogen supply line
46 char return line
47 oxygen supply line
48 foreign matter capture system
49 first raw syngas line
51 collecting device
52 char supply hopper
53 second raw syngas line
54, 55 air flow regulation valve
56 air flow rate adjusting device
61 compressor
62 combustor
63, 69 turbine
64 rotary shaft
66 fuel gas supply line
67 combustion gas supply line
68 booster
70 exhaust gas line
71 steam supply line
72 supply water line
73 condenser
75 stack
76 processor
77 RAM
78 ROM
79 HDD
80 input I/F
81 output I/F
82 bus
101 gasifier
110 pressure vessel
111 gasifier wall
115 annular portion
116 combustor part
117 diffuser part
118 reductor part
119 pressure sensor
122 slag bath
125 char burner
126 combustor system pulverized coal burner
127 reductor system pulverized coal burner
128, 147 valve opening degree setting unit
129 gasifier pressure setting unit
130, 136, 139, 141 subtraction unit
131, 137, 140, 146 control unit
132, 145, 148, 151, 155 addition unit
133 air flow rate setting unit
134 air ratio setting unit
135 multiplication unit
138 fuel flow rate setting unit
142 char level setting unit
143 fuel bias calculation unit
144, 150, 153 gradient setting unit
149 air bias calculation unit
152 switching unit
154 internal space
251, 252, 253 pulverized coal feed hopper (plurality of fuel feed hoppers)
261, 262, 263 discharge valve

1. A gasification unit comprising:
a gasifier for generating a combustible gas by using a carbonaceous feedstock and an oxygen containing gas;
a char storage portion for storing char separated from the combustible gas generated in the gasifier;
a char supply line for supplying the char from the char storage portion to the gasifier;
a char flow rate adjusting device provided in the char supply line for adjusting a char flow rate, which is a flow rate of the char supplied to the gasifier;
a fuel supply line for supplying the carbonaceous feedstock to the gasifier;
a fuel flow rate adjusting device provided in the fuel supply line for adjusting a fuel flow rate, which is a flow rate of the carbonaceous feedstock supplied to the gasifier;
an oxygen containing gas supply line for supplying the oxygen containing gas to the gasifier;
an oxygen containing gas flow rate adjusting device provided in the oxygen containing gas supply line for adjusting an oxygen containing gas flow rate, which is a flow rate of the oxygen containing gas supplied to the gasifier; and
a control device, wherein
the control device is configured to
control the char flow rate adjusting device to control the char flow rate to a flow rate determined according to a load index indicating a load of a unit using the combustible gas, and
control at least one of the fuel flow rate adjusting device and the oxygen containing gas flow rate adjusting device to adjust at least one of the fuel flow rate and the oxygen containing gas flow rate based on a total char level indicating a storage amount of char in the char storage portion.

2. The gasification unit according to claim 1, wherein
when a deviation of a measured value of the total char level with respect to a set value of the total char level is ΔQ, the control device is configured to control at least one of the fuel flow rate adjusting device and the oxygen containing gas flow rate adjusting device such that at least one of the fuel flow rate and the oxygen containing gas flow rate is adjusted according to the deviation ΔQ.

3. The gasification unit according to claim 2, wherein
the control device is configured to generate a fuel flow rate command value, which is a command value of the fuel flow rate, by adding a fuel bias, which is a variable having a negative correlation to the deviation ΔQ, to the fuel flow rate calculated based on the load index, and control the fuel flow rate adjusting device based on the fuel flow rate command value.

4. The gasification unit according to claim 2, wherein
the control device is configured to generate an oxygen containing gas flow rate command value, which is a command value of the oxygen containing gas flow rate, by adding an oxygen containing gas bias, which is a variable having a positive correlation to the deviation ΔQ, to the oxygen containing gas flow rate calculated based on the load index, and control the oxygen containing gas flow rate adjusting device based on the oxygen containing gas flow rate command value.

5. The gasification unit according to claim 1, wherein
the control device is configured to, in a case where the temporary occurrence of the excess or insufficiency in an amount of the heat input to the gasifier is predicted, control the char flow rate adjusting device to temporarily change the char flow rate to suppress the occurrence of the excess or insufficiency.

6. The gasification unit according to claim 5, further comprising:
a plurality of fuel feed hoppers for storing the carbonaceous feedstock; and
a switching device that is provided in the fuel supply line and is capable of switching the fuel feed hopper that supplies the carbonaceous feedstock to the gasifier in the plurality of fuel feed hoppers, wherein
the char flow rate adjusting device is a char flow regulation valve provided in the char supply line, and
the control device is configured to generate a command value of a valve opening degree of the char flow regulation valve set based on the load index by adding a valve opening degree bias that is a positive value to the valve opening degree in a case where a switching command for causing the switching device to switch the fuel feed hopper that supplies the carbonaceous feedstock to the gasifier is generated, and control the valve opening degree of the char flow regulation valve based on the command value of the valve opening degree.

7. The gasification unit according to claim 5, wherein
the char flow rate adjusting device is a char flow regulation valve provided in the char supply line, and
the control device is configured to generate a command value of a valve opening degree of the char flow regulation valve set based on the load index by adding a valve opening degree bias, which is a variable having a positive correlation to an index indicating a time change in the load, to the valve opening degree, and control the valve opening degree of the char flow regulation valve based on the command value of the valve opening degree.

8. An integrated gasification combined cycle comprising:
the gasification unit according to claim 1;
a gas turbine that is rotationally driven by combusting at least a part of a raw syngas generated in the gasifier;
a steam turbine that is rotationally driven by steam generated in a heat recovery steam generator that introduces a turbine exhaust gas discharged from the gas turbine; and
a generator that is connected to the gas turbine and/or the steam turbine for rotational driving.

9. An operating method of a gasifier, the method comprising:
a step of controlling a flow rate of char supplied to the gasifier to a flow rate determined according to a load of a unit that uses a combustible gas generated in the gasifier; and
a step of adjusting at least one of a flow rate of a carbonaceous feedstock to be supplied to the gasifier and a flow rate of an oxygen containing gas to be supplied to the gasifier according to a total char level indicating a storage amount of char in a char storage portion.
